(19) United States
(12) Patent Application Publication
(10) Pub. No.: US 2015/0077049 A1
(43) Pub. Date: Mar. 19, 2015

(54) KEY CHARGING CABINET

(71) Applicant: SKYTRACE, INC., GARDEN CITY, ID (US)

(72) Inventor: ROBERT S. SMITH, REDMOND, WA (US)

(21) Appl. No.: 14/464,609

(22) Filed: Aug. 20, 2014

Related U.S. Application Data
(60) Provisional application No. 61/867,882, filed on Aug. 20, 2013.

(51) Int. Cl. H02J 7/02; G01S 5/02; H02J 7/00

(52) U.S. Cl. CPC H02J 7/025; H02J 7/0044; G01S 5/0294
USPC 320/108

(57) ABSTRACT

A device for wirelessly charging key fobs. The device uses a cabinet with at least one support for supporting a key fob. There is also at least one inductive charging unit placed to wirelessly charge a key fob that is placed on the support. The device further includes a power supply to deliver power to each inductive charging unit.

### PRIORITY/CROSS-REFERENCE TO RELATED APPLICATIONS

This application claims the benefit of U.S. Provisional Application No. 61/867,882, filed Aug. 20, 2013, the disclosure of which is incorporated by reference.

### TECHNICAL FIELD

The presently disclosed and claimed inventive concepts generally relate to a system for wirelessly charging key fobs and more particularly inductively charging key fobs and GPS enabled tracking systems.

### BACKGROUND

Electronic key fobs have become increasingly prevalent in modern society. Most modern cars use key fobs in order to perform various functions from a remote distance. These functions include operating door locks, rolling up or down windows, operating the sunroof as well as starting the vehicle. The key fobs run on a battery system. This results in a system that is only functional as long as the battery has power.

As additional features are added to the key fob's capabilities the drain on the battery increases. This increased battery drain could result in key fobs operating at shorter and shorter distances until finally the key fob is inoperable. An inoperable key fob can result in significant inconvenience if the user is unable to enter the vehicle as well as significant danger if the outside conditions present a hostile environment such as in extreme cold conditions.

To further complicate this situation, the key fob must be able to fit into a pocket or a purse. Many people place the key fob on their key chain and then into their pocket or purse. The small size requirement results in a smaller battery as well as an inability to place significant charging capabilities, such as cable port. It would be advantageous to create a key fob and system that retains the small size while allowing a user to recharge the key fob in order to prevent the battery becoming nonfunctional.

### SUMMARY OF THE DISCLOSURE

Disclosed is a device for wirelessly charging a key fob. The device is in the shape of a cabinet preferably having sides and a door in order to conceal the contents. The cabinet features supports for the placement of key fobs. Each support is coupled with an inductive charging unit so that when a key fob is placed on the supports, the inductive charging unit will charge a key fob that is manufactured to facilitate inductive charging. The supports can be of many designs such as hooks, platforms, holsters, cradles or hook and loop fasteners. Additionally, there is a power supply connected to the cabinet. The power supply provides power to each inductive charging unit so that any key fob placed correctly on a support will automatically be charged. The inductive charging units can be attached to the back panel of the charging cabinet in which case, one option would be a hook also attached to the back panel. The inductive charging unit should be placed at an optimal depth within the back panel as well as optimally placed on the back panel in relation to the support in order to allow maximum charging. If the supports are made to be a platform, the inductive charging units can be placed under the surface of the platform. This would allow for a user to simply place the key fob on the support and charging will commence. This can be done with individual charging units in individual platforms or with individual charging units within one platform or one charging unit within a large platform capable of charging multiple key fobs simultaneously.

Also disclosed is a system for charging and tracking key fobs. The system involves the use of multiple key fobs with each key fob having a separate battery, vehicle control functions, and a GPS tracking device that is all powered by the battery. Alternatively, the GPS tracking device can be a separate unit, with an individual battery, from the vehicle control fob. The system further includes a storage rack, such as a cabinet, that is configured for charging of multiple key fobs. This cabinet is similar to the one described above where there are multiple supports for the key fobs. Additionally, there are one or more inductive charging units included in the cabinet that charge the key fobs when the key fobs are correctly placed on the supports. A power supply is included for delivering power to the inductive charging units. This system further has GPS tracking capabilities within each key fob. This capability allows a user to track the whereabouts of the key fob in order to determine its location which could be within the cabinet, with a user or misplaced elsewhere. As described above, the supports can be of various types such as hook and loop fasteners, individual platforms, hooks, holsters, cradles or other systems for supporting the key fobs. Further, the inductive charging units can be imbedded within the platforms or within the back panel or side panel of the cabinet depending on the support system chosen.

### BRIEF DESCRIPTION OF THE DRAWINGS

FIG. 1 is a view of a charging cabinet in accordance with an embodiment of the inventive concepts.

FIG. 2 is a front view of a key fob support in accordance with an embodiment of the inventive concepts.

FIG. 3 is a front view of a key fob placed in a support in accordance with an embodiment of the inventive concepts.

FIG. 4 is a front view of a key fob charging rack in accordance with an embodiment of the inventive concepts.

FIG. 5 is a view of a key fob in accordance with an embodiment of the inventive concepts.

### DETAILED DESCRIPTION OF THE EXEMPLARY EMBODIMENTS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

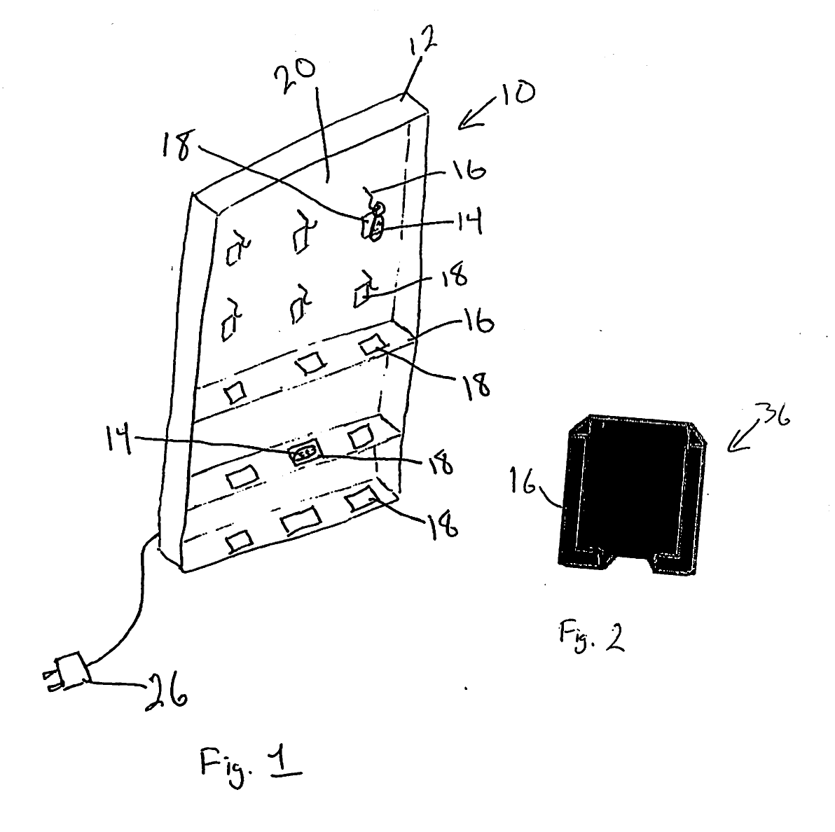

Shown in FIG. 1 is device 10 for wirelessly charging multiple key fobs. The device 10 is created by use of rack 42, shown as cabinet 12. Cabinet 12 can feature doors or other mechanisms to conceal the interior but these features are not necessary for the disclosed concepts. Cabinet 12 features multiple supports 16 for supporting the key fobs 14 during charging. These supports 16 can be of various designs. Shown in FIG. 1 are platforms 30 and hooks 28 which are used as supports 16. Hooks 28 can be used when the key fob 14 has a ring, or other hanging support, attached in order to support the key fob 14. Platforms 30 are useful when the key fob 14 needs to be supported without the use a hanger so that the key fob 14 can rest on the platform 30.

Each support 16 is coupled an inductive charging units 18. Each inductive charging unit 18 is placed to optimize the charging of the key fob 14 when the key fob 14 is placed on the associated support 16. When supports 16 are hooks 28, the inductive charging unit 18 can be placed in the back panel 20 of cabinet 12. When placing the inductive charging unit 18 in the back panel 20 of cabinet 12 the inductive charging unit 18 is placed at an optimal height relative to the support 16 as well as an optimal depth in relation to support 16 and back panel 20 so that the key fob 14 sits at the most efficient and effective position relative to inductive charging unit 18.

In the alternative embodiment where support 16 are platforms 30, the inductive charging units 18 can be placed into the support 16. In this embodiment, the key fob 14 is placed directly on top of the support 16 with the inductive charging unit 18 placed at an optimal depth within the support 16. In one embodiment, multiple inductive charging units 18 are placed within each platform that is being used for support 16. The embodiment shown in FIG. 1 shows a potential for three key fobs 14 being placed on each platform. As one alternative to this system, one long inductive charging unit 18 can be placed to run the entirety of the support 16 wherein the support 16 is a platform 30. The key fobs 14 can be placed anywhere along the platform 30 as long as they are oriented correctly with the inductive charging unit 18. A similar system can be used for the hooks, wherein a single inductive charging unit 18 runs vertically or horizontally in order to charge each key fob 14 that is placed on a hook 28.

Also shown in FIG. 1 are two separate key fobs 14. One key fob 14 is supported by hook 28 and the other by platform 30. Each of these key fobs 14 is placed adjacent to an inductive charging unit 18 to allow the key fob 14 to charge while being stored in the cabinet 12. This allows the key fob battery to be at full charge when it is removed from the cabinet 12, preventing the user from having an unusable key fob 14 that can result in potentially dangerous situations where a user cannot enter the vehicle during adverse weather. In order for the inductive charging units 18 to wirelessly charge the key fobs 14, power supply 26 is attached. Power supply 26 can be of various styles with FIG. 1 showing an a/c power supply such as what would plug into a standard home power outlet. Other power supplies are foreseeable, such as solar power or batteries. The power supply 26 is attached to each inductive charging unit 18 in order to supply power. If large numbers of inductive charging units 18 are utilized, a higher wattage power supply 26 can be used, or multiple power supplies 26 can be used.

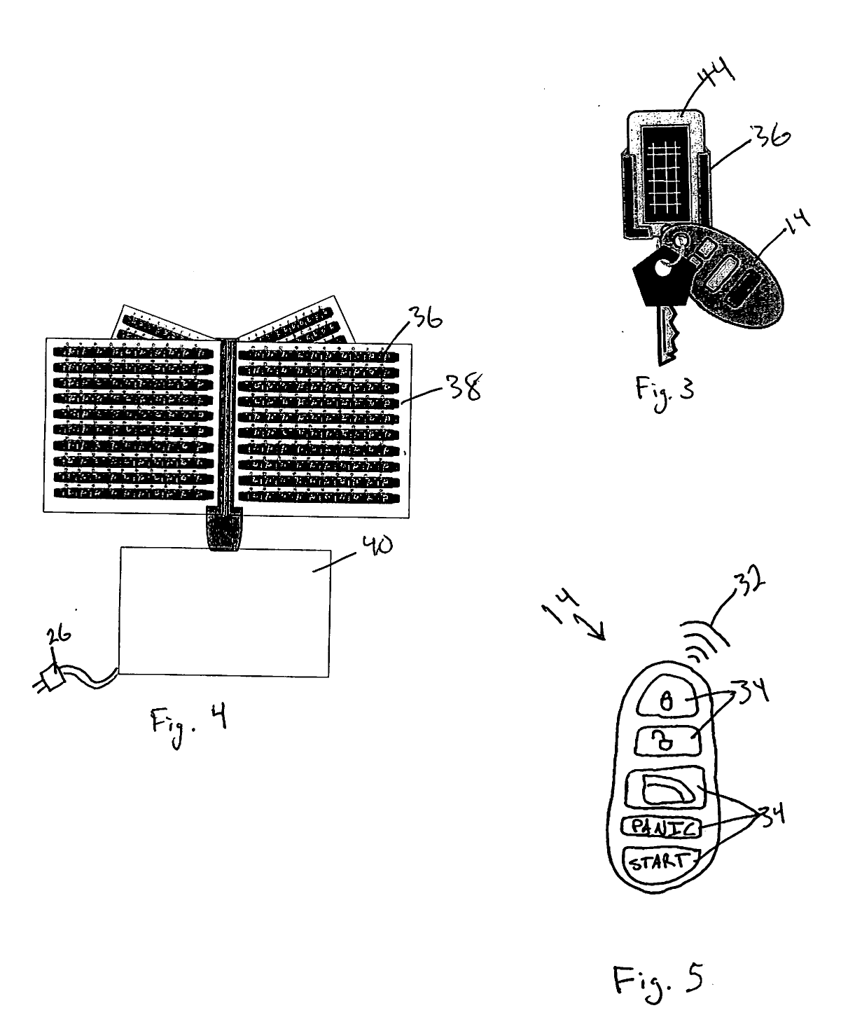

FIG. 2 shows another possible design of support 16. Shown in FIG. 3 is the use of cradle 36 to charge a GPS tracking device 44. The cradle 36 can be used to charge the GPS tracking device 44 as well as the key fob 14. As shown in FIG. 4, cradle 36 is preferably designed to hold a single key fob 14. The cradle 36 holds the key fob 14 at an optimized location relative to an inductive charging unit 18. FIG. 5 shows an embodiment where the rack 42 is configured to be a series of panels 38 with cradles 36 attached. The panels 38 can be single or double sided. In the double sided configuration a single inductive charging unit can be used to charge key fobs stored on both sides. The panels are supported by base 40 that is large enough to provide support and balance to the panels. In certain embodiments the base 40 can have internal storage. Attached to base 40 is power supply 26. Power supply 26 is further attached to the inductive charging units 18. The panels 38 can be supported in multiple additional ways including being attached to a wall or sliding rack systems.

Also disclosed is a system for charging and tracking key fobs. The charging system is identical to the system described above but the key fobs 14, as shown in FIGS. 3 and 5, have an additional feature of a GPS tracking device 44 that is also powered by the battery. The GPS tracking device 44 can be included in the key fob 14, as shown in FIG. 5, or operated as a separate unit, as shown in FIG. 3. The key fob 14 shown has multiple buttons 34 for performing tasks. While specific functions are shown, other functions could be included such as opening of a trunk or a gas cap cover. This GPS transmitter supplies a signal 32 in order to be located by a user at another location. The GPS transmitter will send a signal 32 so that a user can identify if the key fob 14 is in the cabinet, if it is being moved or if it is located within the building but not in the cabinet. This system would be advantageous in locations where multiple key fobs 14 are being used such as in a vehicle rental facility or a construction company where multiple vehicles are used or other similar operations. The GPS locator allows a user who needs a specific vehicle to quickly locate the key fob 14 and therefore the keys to the vehicle rather than wasting valuable time searching for the key fob in order to continue working.

While certain exemplary embodiments are shown in the figures and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

We claim:

1. A device for wirelessly charging a key fob comprising:
a rack configured for storage of multiple key fobs;
a plurality of supports for said multiple key fobs;
one or more inductive charging units attached to said charging cabinet; and
a power supply for powering said one or more inductive charging units, with said power supply being connected to said inductive charging units.

2. The device of claim 1 wherein said inductive charging units are attached adjacent to a back panel of said charging cabinet.

3. The device of claim 1 wherein said supports are hooks.

4. The device of claim 1 wherein said supports are platforms.

5. The device of claim 4 wherein said inductive charging units are imbedded in said platforms.

6. The device of claim 1 wherein said inductive charging units are installed to align with said plurality of support points.

7. The device of claim 1 wherein said inductive charging units are imbedded in a back panel of said cabinet.

8. The device of claim 1 wherein said rack is a cabinet.

9. A key fob tracking and charging system comprising:
a plurality of key fobs, each fob comprising a battery, vehicle control functions, and a GPS powered by said battery;
a cabinet configured for storage of multiple key fobs;
a plurality of supports for said multiple key fobs;
one or more inductive charging units attached to said cabinet; and
a power supply for powering said one or more inductive charging units, with said power supply being connected to said inductive charging units, wherein said GPS chips providing tracking capabilities of said key fob.

10. The system of claim 9 wherein said supports are hook and loop fasteners.

11. The system of claim 9 wherein said supports points are platforms.

12. The system of claim 9 wherein said inductive charging units are imbedded in said platforms.

13. A key fob tracking and charging system comprising:
a plurality of key fobs, each fob comprising a battery and vehicle control functions; and
a plurality GPS tracking device;
a cabinet configured for storage of said plurality key fobs and said plurality GPS tracking devices;
a plurality of supports for said plurality key fobs and said plurality GPS tracking devices;
one or more inductive charging units attached to said cabinet; and
a power supply for powering said one or more inductive charging units, with said power supply being connected to said inductive charging units, wherein said plurality of GPS tracking devices providing tracking capabilities.
